(19) United States
(12) Patent Application Publication
(10) Pub. No.: US 2008/0051964 A1
(43) Pub. Date: Feb. 28, 2008

(54) Operating unit of a vehicle having an automatic braking device

(76) Inventor: Hiroyuki Maeda, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/807,537

(22) Filed: May 29, 2007

Related U.S. Application Data
(63) Continuation of application No. 09/648,290, filed on Aug. 24, 2000, now abandoned.

(30) Foreign Application Priority Data
Aug. 24, 1999 (JP) 11-236293

(51) Int. Cl. G06F 19/00

(52) U.S. Cl. 701/70

(57) ABSTRACT

If a fire brakes out on a road, e.g. inside a tunnel, the road becomes in a high temperature, and hence a vehicle becomes dangerous if it enters the tunnel. Accordingly, it is desired that an automatic braking device of a vehicle is operated automatically in response to a signal formed of an electromagnetic wave. A transmitter for transmitting a signal formed of an electromagnetic wave is provided on a road. The automatic braking device and a receiver are respectively provided in the vehicle, wherein the automatic braking device drives a pump when the receiver receives the signal, operating an automatic brake to wheel brakes provided in a pair of right and left front wheels and/or rear wheels, so that an antilock control device is operable during the operation of the automatic braking device. The receiver outputs a control signal in response to the signal transmitted by the transmitter, and the automatic braking device is operated in response to the control signal outputted by the receiver.

### BACKGROUND OF THE INVENTION

1. Field of the Invention

The invention relates to an operating unit of a vehicle having an automatic braking device, more particularly to a unit for operating an automatic braking device of a vehicle and a unit for giving an alarm to the inside of the vehicle by a sound using automatic braking device.

2. Related Art

There has been recently proposed an automatic braking device for operating a brake automatically to a vehicle regardless of intention of a driver (depression of a brake pedal). An automatic braking device of this type can be structured on the basis of a conventional antilock control device.

Meanwhile, there exists a tunnel on a travelling road (hereinafter referred to as a road) of a vehicle. If a fire brakes out in the tunnel, the tunnel becomes in a high temperature and produces carbon monoxide gas and other toxic gas. Accordingly, it is desired not only to give an alarm of the occurrence of the fire to the inside of the vehicle by a buzzer, lump, or the like, but also to forcibly restrain the vehicle from entering the tunnel.

### SUMMARY OF THE INVENTION

It is an object of the invention to automatically operate an automatic braking device of a vehicle in response to a signal formed of an electromagnetic wave outputted by a transmitter that is provided on a road while efficiently utilizing an already-existing automatic braking device.

It is another object of the invention to give an alarm of danger to the inside of the vehicle by a sound in response to a signal formed of an electromagnetic wave outputted by a transmitter that is provided on a road while efficiently utilizing a receiver of the already-existing automatic braking device of the vehicle.

Particularly, it is an object of the invention to automatically prevent a vehicle from entering a tunnel when a fire brakes out in the tunnel, thereby improving the safety of the vehicle.

The invention has been developed in view of the conventional technical problems, and has the following constructions to achieve the above objects.

The operating unit of a vehicle 8 having an automatic braking device 6 according to the first aspect of the invention is applied to the vehicle 8 travelling on a road 2 provided with a transmitter 4 for transmitting a signal T2 formed of an electromagnetic wave and comprises the automatic braking device 6 and a receiver 7 that are respectively provided in the vehicle 8, and wherein the automatic braking device 6 drives a pump 60 when the receiver 7 receives the signal T2 formed of an electromagnetic wave, applying or operating an automatic brake to wheel brakes 53, 53′ provided in a pair of right and left front wheels and/or rear wheels, so that an antilock control device is operable during the operation of the automatic braking device 6, and wherein the receiver 7 outputs a control signal T3 in response to the signal T2 transmitted by the transmitter 4, and the automatic braking device 6 is operated in response to the control signal T3 outputted by the receiver 7.

The operating unit of a vehicle having an automatic braking device 6 according to the second aspect of the invention comprises a transmitter 4 provided on a road 2 for transmitting a signal T2 formed of an electromagnetic wave, the automatic braking device 6 and a receiver 7 that are respectively provided in the vehicle 8, and wherein the automatic braking device 6 drives a pump 60 when the receiver 7 receives the signal T2 formed of an electromagnetic wave, operating an automatic brake to wheel brakes 53, 53′ provided in a pair of right and left front wheels and/or rear wheels, so that an antilock control device is operable during the operation of the automatic braking device 6, and wherein the receiver 7 outputs a control signal T3 in response to the signal T2 transmitted by the transmitter 4, and the automatic braking device 6 is operated in response to the control signal T3 outputted by the receiver 7.

The operating unit of a vehicle having an automatic braking device 6 according to the third aspect of the invention, the operating unit of a vehicle according to the first aspect of the invention further comprises reference value setting means 83 provided in the vehicle 8, and wherein the automatic braking device 6 is operated based on a reference value t corresponding to a target travelling speed set by the reference value setting means 83 in response to the control signal T3.

The operating unit of a vehicle having an automatic braking device according to the fourth aspect of the invention, the operating unit of a vehicle according to the first aspect of the invention further comprises travelling speed detection means 81 provided in the vehicle 8 for detecting a travelling speed of the vehicle 8 in response to the control signal T3 and outputting an output signal T4 so as to operate the automatic braking device 6.

The operating unit of a vehicle having an automatic braking device according to the fifth aspect of the invention, the operating unit of a vehicle according to the first aspect of the invention further comprises at least one temperature detection means 3 provided on the road 2 for detecting that an atmospheric temperature reaches a given temperature and outputting a temperature signal T1, and wherein the transmitter 4 transmits the signal T2 in response to the temperature signal T1 outputted by the temperature detection means 3.

The operating unit of a vehicle 8 having an automatic braking device 6 according to the sixth aspect of the invention is applied to the vehicle 8 travelling on a road 2 provided with a transmitter 4 for transmitting a signal T2 formed of an electromagnetic wave and comprises the automatic braking device 6 and a receiver 7 that are respectively provided in the vehicle 8, and wherein the automatic braking device 6 drives a pump 60 when the receiver 7 receives the signal T2 formed of an electromagnetic wave, operating an automatic brake to wheel brakes 53, 53′ provided in a pair of right and left front wheels and/or rear wheels, so that an antilock control device is operable during the operation of the automatic braking device 6, and wherein the receiver 7 outputs a control signal T3 in response to the signal T2 transmitted by the transmitter 4, and wherein an alarm is given to the inside of the vehicle 8 by a sound in response to the control signal T3 outputted by the receiver 7.

The operating unit of a vehicle having an automatic braking device 6 according to the seventh aspect of the invention comprises a transmitter 4 provided on a road 2 for transmitting a signal T2 formed of an electromagnetic wave, the automatic braking device 6 and a receiver 7 that are respectively provided in the vehicle 8, and wherein the automatic braking device 6 drives a pump 60 when the receiver 7 receives the signal T2 formed of an electromagnetic wave, operating an automatic brake to wheel brakes 53, 53′ provided in a pair of right and left front wheels and/or rear wheels, so that an antilock control device is operable during the operation of the automatic braking device 6, and wherein the receiver 7 outputs a control signal T3 in response to the signal T2 transmitted by the transmitter 4, and wherein an alarm is given to the inside of the vehicle 8 by a sound in response to the control signal T3 outputted by the receiver 7.

The operating unit of a vehicle having an automatic braking device according to the eighth aspect of the invention, the operating unit of a vehicle according to the sixth aspect of the invention further comprises at least one temperature detection means 3 provided on the road 2 for detecting that an atmospheric temperature reaches a given temperature and outputting a temperature signal T1, and wherein the transmitter 4 transmits the signal T2 in response to the temperature signal T1 outputted by the temperature detection means 3.

The operating unit of a vehicle having an automatic braking device according to the ninth aspect of the invention, wherein the temperature detection means 3 according to the fifth aspect of the invention is provided in the tunnel 1.

The operating unit of a vehicle having an automatic braking device according to the tenth aspect of the invention, wherein the transmitter 4 according to the ninth aspect of the invention is provided at one of the position of an opening portion 1a serving as an approach to the tunnel 1 and the position remote from the opening portion 1a serving as the approach to the tunnel 1 by a given distance L.

### BRIEF DESCRIPTION OF THE DRAWINGS

FIG. 1 is a sectional view of an operating unit of a vehicle having an automatic braking device according to a preferred embodiment of the invention, wherein a part of the operating unit is omitted;

FIG. 2 is a view showing constituents of the operating unit of a vehicle having an automatic braking device; and

FIG. 3 is a flow chart showing the control of an automatic braking device.

### PREFERRED EMBODIMENT OF THE INVENTION

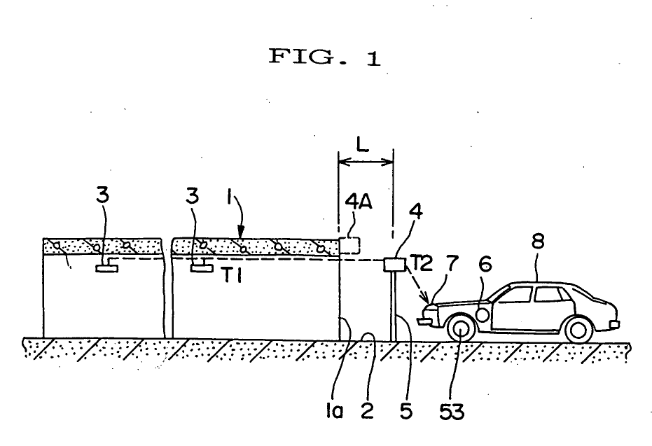

An operating unit of a vehicle having an automatic braking device according to a preferred embodiment of the invention is described now with reference to FIGS. 1 to 3.

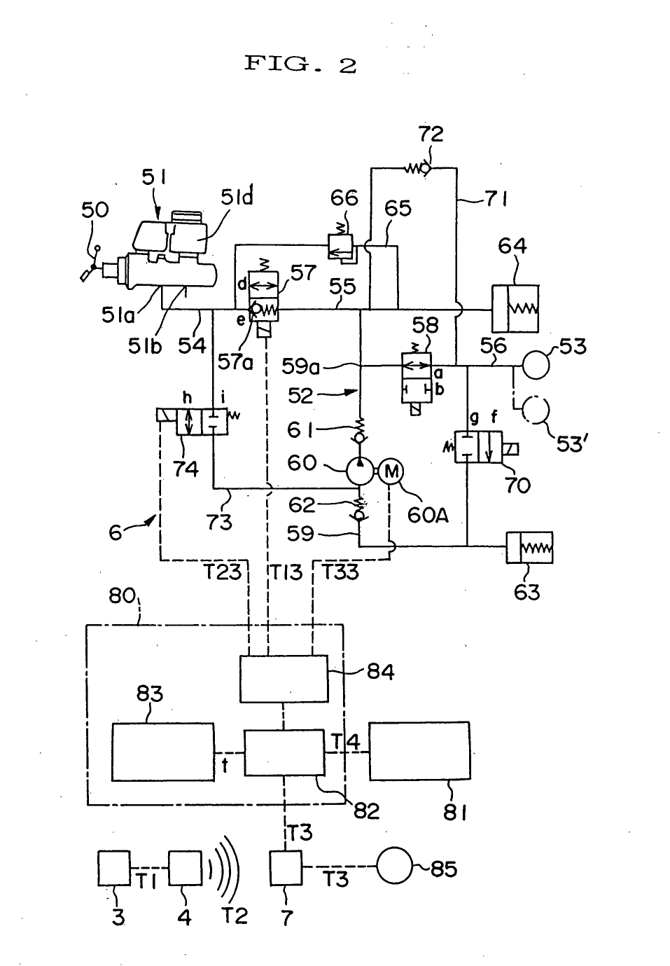

In FIGS. 1 and 2, a tunnel 1 is positioned at an appropriate location of a road 2 and forms a part of the road 2. The tunnel 1 is shown by a cross section in FIG. 1 wherein a part of the tunnel 1 is omitted, and the tunnel 1 forms a one way road. At least one temperature detection means 3 is installed on the upper portion inside the tunnel 1. The temperature detection means 3 has a function to detect the increase of a temperature when a fire brakes out inside the tunnel 1, and outputs a temperature signal T1 when an atmospheric temperature exceeds a given temperature (e.g., 80° C.) at the time when the fire broke out. Accordingly, the temperature detection means 3 can be formed of not only a temperature sensor but also a temperature switch for outputting the temperature signal T1 while a contact is closed when the atmospheric temperature exceeds the given temperature.

A transmitter 4 is connected to the temperature detection means 3. The transmitter 4 is installed outside the tunnel 1, and transmits a danger signal T2 formed of an electromagnetic wave in response to the temperature signal T1 by the temperature detection means 3. The transmitter 4 is installed on the road 2 at the front side of the tunnel 1, namely, at the position remote from an opening portion 1a of an approach to the tunnel 1 by a given distance L. More in detail, a strut 5 is installed at either side of the road 2 at the position remote from the opening portion 1a of the approach to tunnel 1 by a given distance L, and the transmitter 4 is fixed to the top of the strut 5 of a given height. If the transmitter 4 is formed of a type for transmitting infrared rays, a communicate can be effected within a short distance. Meanwhile, if the transmitter 4 is a type for transmitting a wave such as a microwave, a communication can be effected from a long distance. The transmitter 4 can be fixed to a wall surface of the tunnel 1 at the opening portion 1a such as a transmitter 4A as shown by one-dotted chain lines in FIG. 1. If the tunnel 1 is formed of a two-way road, two approaches to the tunnel 1 exist at both ends thereof, and plural transmitters 4, 4A can be provided at the positions corresponding to both approaches to the tunnel 1.

A vehicle 8 has an automatic braking device 6 and a receiver 7 and travels on the road 2, then gradually approaches the tunnel 1. The receiver 7 receives the danger signal T2 outputted by the transmitter 4 and outputs a control signal T3 as shown in FIG. 2 to operate the automatic braking device 6.

An example of the automatic braking device 6 is explained with reference to FIG. 2. The automatic braking device 6 functions also as an antilock control device. A hydraulic generating device or master cylinder 51 is a tandem master cylinder wherein a brake liquid for use in braking operation is supplied through a plurality of liquid supply ports 51a, 51b by depressing a brake pedal 50.

The liquid supply port 51a is connected to at least one wheel brake 53 via an actuator 52 serving as an antilock control device. The wheel brake 53 is a disc brake or a drum brake serving as braking elements of the vehicle 8 and it is for use in front wheels or rear wheels. The wheel brake 53 is one of the right and left front wheels, and the wheel brakes 53, 53′ are used for a pair of front wheels.

A main passage is formed by a first passage 54, a second passage 55 and a third passage 56 between the master cylinder 51 and wheel brake 53 while serially connecting a blocking valve 57 and a first selector valve 58. The first selector valve 58 has one end connected to the other end of the third passage 56 that is connected to the wheel brake 53 or 53′, and also has pressure increasing position a serving as a communication position, and a pressure holding/reducing position b serving as a shut-off position. The first selector valve 58 has the other end connected to the blocking valve 57 via the second passage 55 that is formed of a Z shape. The first selector valve 58 is normally positioned at the pressure increasing position a.

The blocking valve 57 has the other end connected to one end of the first passage 54 that is connected to the liquid supply port 51a of the master cylinder, and normally positioned at a communication position d. The blocking valve 57 is switched from the communication position d to a shut-off position e while the antilock control device operates owing to the occurrence of a skid in the wheels or the automatic braking device 6 operates. The blocking valve 57 has a second check valve 57a at the shut-off position e as shown in FIG. 2 for preventing a brake fluid from returning from an accumulator 64, described later, to the master cylinder 51. The second check valve 57a may be provided by connecting the first passage 54 and second passage 55 while detouring the blocking valve 57. Although the accumulator 64 is connected, in FIG. 2, to the second passage 55 between a connection point 59a of a pressure reduction passage 59, described later, and the blocking valve 57, it may be connected to the portion adjacent to the other end of the pressure reduction passage 59.

Third and fourth check valves 61, 62 are connected to both sides of the pump 60 driven by a motor 60A and the pressure reduction passage 59 has the other end connected to the second passage 55 at the connection point 59a and one end connected to the third passage 56 (wheel brake 53 ) via a reservoir 63 and a second selector valve 70. Accordingly, the pressure reduction passage 59 is provided whiel detouring the first selector valve 58. The second selector valve 70 has a communication position f and a shut-off position g, and is normally positioned at the shut-off position g. Third and fourth check valve 61, 62 allows the brake fluid to flow from the side of the wheel brake 53 toward the side of the master cylinder 51 (accumulator 64). The brake fluid which enters from the wheel brake 53 inside the reservoir 63 can drive the pump 60 and then it can be discharged.

A bypass line 71 is provided between the second passage 55 and the third passage 56 while intervening the first check valve 72. The bypass line 71 has a function to return the brake fluid from the wheel brake 53 while detouring the first selector valve 58. A relief valve 66 provided in an overflow circuit 65 has a function to return a brake fluid having a pressure that exceeds a given pressure inside the accumulator 64 to the master cylinder 51 through the overflow circuit 65 while detouring the blocking valve 57.

One end of a suction passage 73 is connected to the pressure reduction passage 59 between the pump 60 and second selector valve 70. The suction passage 73 intervenes a charging valve 74 therein and has the other end connected to the reservoir tank 51d, resulting in connecting to the reservoir tank 51d of the master cylinder 51. The charging valve 74 has a communication position h and a shut-off position i and is normally positioned at the shut-off position i.

The blocking valve 57, first selector valve 58, second selector valve 70 and charging valve 74 are respectively formed of a solenoid valve, and they are connected to a microcomputer 80, wherein when they are energized at respective solenoid portions, they are switched from the normal position (a, d, g, i) to the other position (b, e, f, h) against elasticity. Further, the motor 60A, receiver 7 and travelling speed detection means 81 are respectively connected to the microcomputer 80. The travelling speed detection means 81 detects travelling speed of the vehicle 8 based on rpm of the wheels and drive shafts or the like, then outputs a travelling speed signal T4.

The microcomputer 80 has a function of comparison means 82, reference value setting means 83 for setting a reference value t corresponding to a given travelling speed of the vehicle 8 and operation signal generating means 84. The operation signal generating means 84 outputs operation signals T13, T23 and T33 until the travelling speed signal T4 becomes less than the reference value t, namely, until the travelling speed does not reach a given value based on the result of comparison between the travelling speed signal T4 and the reference value t by the comparison means 82. The reference value t corresponds to a target low travelling speed and is normally a value corresponding to a travelling speed of zero. The operation signal T13 is supplied to the solenoid portion of the blocking valve 57 while the operation signal T23 is supplied to the solenoid portion of the charging valve 74, and the operation signal T33 is supplied to the motor 60A so as to control them, as necessary.

The operation of the antilock control device by the automatic braking device 6 is described next.

If the locking of the wheels is detected by a wheel rotary sensor, not shown, when depressing the brake pedal 50 while operating a brake, the microcomputer 80 receives a signal outputted by the wheel rotary sensor to issue an instruction so that the antilock control device operates to produce a braking force. That is, when the blocking valve 57 is positioned at the shut-off position e while the second selector valve 70 is positioned at the communication position f and the first selector valve 58 is positioned at the pressure holding/reducing position b, so that a brake fluid pressure of the wheel brake 53 is reduced and a brake fluid is reserved in the reservoir 63. When the motor 60A and pump 60 operate, a brake fluid pressure in the reservoir 63 is accumulated in the accumulator 64. This is a pressure reducing process. When the second selector valve 70 is positioned at the shut-off position g and the first selector valve 58 is positioned at the pressure holding/reducing position b, a brake fluid of the wheel brake 53 is kept at a given pressure. This is a pressure holding process.

If a braking force does not reach a given value, the second selector valve 70 is positioned at the shut-off position g and the first selector valve 58 is positioned at the pressure increasing position a so as to increase the pressure again. As a result, a brake fluid reserved in the accumulator 64 when a pressure is reduced is supplied to the wheel brake 53 through the first selector valve 58. This is a pressure increasing process. Since the blocking valve 57 may be kept at the shut-off position e in the pressure increasing process, there does not occur a kickback relative to the brake pedal 50.

Further, when the brake pedal 50 is depressed strong in a state where the blocking valve 57 is positioned at the shut-off position e where the second check valve 57a is provided so that the pressure in the first passage 54 exceeds the pressure in the second passage 55, the brake fluid passes through the second check valve 57a of the blocking valve 57 and is reserved in the accumulator 64. As a result, the brake pedal 50 can be depressed to a further stroke so that degradation of feeling of depression of the brake pedal 50 is avoided.

The operation of the automatic braking device 6 when a fire brakes out in the tunnel 1 is described now.

When a fire brakes out in the tunnel 1, the increase of an atmospheric temperature caused by the fire is detected by the temperature detection means 3, and the temperature detection means 3 outputs the temperature signal T1. The temperature signal T1 outputted by the temperature detection means 3 is inputted to the transmitter 4, and the transmitter 4 outputs the danger signal T2 which is received by the receiver 7 of the vehicle 8 which travels on the road 2 toward the tunnel 1. As a result, the receiver 7 outputs the control signal T3 based on which the automatic braking device 6 is controlled by the microcomputer 80.

The automatic braking device 6 is controlled in the following manner. That is, the blocking valve 57 is switched to the shut-off position e, and the charging valve 74 is switched to the communication position h so that the motor 60A is driven, resulting in driving the pump 60. In consequence, the brake fluid reserved in the reservoir tank 51d of the master cylinder 51 passes through the suction passage 73, pressure reduction passage 59, second passage 55 and third passage 56, then it is supplied to the wheel brake 53, thereby producing a braking force.

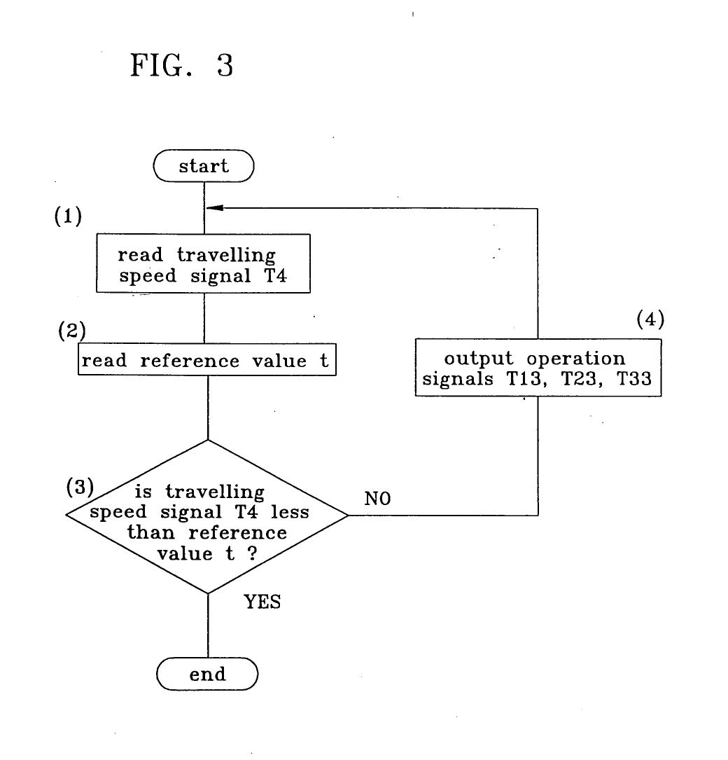

The braking force produced by the wheel brake 53 is continuously produced until the travelling speed signal T4 becomes less than the reference value t in accordance with the flow chart in FIG. 3. That is, a program starts when the control signal T3 is outputted by the receiver 7, and the travelling speed signal T4 outputted by the travelling speed detection means 81 is read (step (1)). Further, the reference value t of the reference value setting means 83 is read (step (2)). Then the reference value t is compared with the travelling speed signal T4 by the comparison means 82 (step (3)). If the travelling speed signal T4 exceeds the reference value t, the program goes to a step (4) where the operation signals T13, T23, T33 are outputted, and then the program is returned to the step (1). When the program repeats the steps (1) to (4), the travelling speed signal T4 becomes less than the reference value t, so that the operation signals T13, T23, T33 are not outputted. In consequence, the control of the automatic braking device 6 is completed. If the reference value t is a value corresponding to a travelling speed of zero, the operation signals T13, T23, T33 are continuously outputted until the vehicle 8 stops so that the automatic braking device 6 operates.

The operation signal T13 is supplied to the solenoid portion of the blocking valve 57 so that the blocking valve 57 is positioned at the shut-off position e. The operation signal T23 is supplied to the solenoid portion of the charging valve 74 so that the charging valve 74 is positioned at the communication position h. The operation signal T33 is supplied to the motor 60A so as to drive the pump 60. The antilock control device is operable even while the automatic braking device 6 operates as set forth above, thereby preventing the wheels from being locked.

When the outputting of the operation signals T13, T23, T33 is completed, the blocking valve 57 is returned to the communication position d by elasticity, and the charging valve 74 is returned to the shut-off position i by elasticity so that the motor 60A is stopped, resulting in stopping the pump 60. As a result, the brake fluid inside the wheel brake 53 passes through the third passage 56, second passage 55 and first passage 54 and is returned to the master cylinder 51. The brake fluid inside the wheel brake 53 is returned to the master cylinder 51 even if the second selector valve 70 and charging valve 74 are respectively positioned at the communication positions f and h. As a result, the operation of the automatic braking device 6 is completed. Since the vehicle 8 is prevented from entering the tunnel 1 by the operation of the automatic braking device 6, it is possible to avoid a situation that the vehicle 8 is influenced by a fire occurred inside the tunnel 1.

There is a sufficient case where a brake is applied to at least one wheel brake 53 so that the vehicle 8 is moved to the position deviated from the road 2 while a travelling speed is set to be less than a given value. However, a brake is normally applied to the wheel brakes 53, 53′ provided in a pair of right and left front wheels (or rear wheels) or wheel brakes provided in all the front and rear wheels so as to produce uniform and large braking force at the right and left wheels of the vehicle 8, thereby stopping the vehicle 8 on the road 2 in front of the tunnel 1.

As shown in FIG. 2, it is possible to give an alarm to the inside of the vehicle 8 by a sound or buzzer when a fire is broken out or an accident occurs in the tunnel 1 in response to the control signal T3 outputted by the receiver 7 of the automatic braking device 6 by providing a sound alarm device 85 on the vehicle 8.

According to the preferred embodiment of the invention, although the temperature detection means is provided for detecting the high temperature in the tunnel 1 to restrain the vehicle 8 from entering the tunnel 1, it is possible to provide gas detecting means, not shown, for detecting the production of carbon monoxide or other toxic gases inside the tunnel 1 to restrain the vehicle 8 from entering the tunnel 1. Further, it is possible to provide a switch provided in a tunnel, not shown, that is manually operated so that the transmitter 4 transmits the danger signal T2 when a colliding accident or the like occurs in the tunnel, thereby restraining the vehicle 8 from entering the tunnel 1.

As is well understood from the above explanation, the operating unit of a vehicle having an automatic braking device of the invention has the following effects.

First of all, since the already-existing automatic braking device can be utilized efficiently, the number of parts to be added is considerably reduced, thereby realizing the operating unit of a vehicle having a simple construction.

According to the first to fifth aspects of the invention, the automatic braking device of the vehicle can be automatically operated in response to the signal formed of an electromagnetic wave transmitted by the transmitter provided on the road so as to produce a braking force efficiently utilizing the already-existing automatic braking device of the vehicle. As a result, the safety of the vehicle is improved.

According to the sixth to tenth aspects of the invention, an alarm of danger is given to the inside of the vehicle by a sound in response to the signal formed of an electromagnetic wave transmitted by the transmitter provided on the road efficiently utilizing the already-existing receiver of the automatic braking device of the vehicle. As a result, the safety of the vehicle is improved.

According to the fifth and eighth aspects of the invention, it is possible to prevent in advance the vehicle from travelling toward a fire spot when a fire brakes out on a road, e.g. inside a tunnel so that the vehicle is avoided to be influenced by the fire. As a result, the safety of the vehicle is improved.

What is claimed is:

1. An operating unit of a vehicle having an automatic braking device that is applied to the vehicle travelling on a road provided with a transmitter for transmitting a signal formed of an electromagnetic wave comprising:
said automatic braking device and a receiver being respectively provided in the vehicle, wherein the automatic braking device drives a pump when the receiver receives the signal formed of an electromagnetic wave, operating an automatic brake to wheel brakes provided in a pair of right and left front wheels and/or rear wheels, so that an antilock control device is operable during the operation of the automatic braking device;
said receiver outputting a control signal in response to the signal transmitted by the transmitter; and
said automatic braking device being operated in response to the control signal outputted by the receiver.

2. An operating unit of a vehicle having an automatic braking device comprising:
a transmitter provided on a road for transmitting a signal formed of an electromagnetic wave;
said automatic braking device and a receiver being respectively provided in the vehicle, wherein the automatic braking device drives a pump when the receiver receives the signal formed of an electromagnetic wave, operating an automatic brake to wheel brakes provided in a pair of right and left front wheels and/or rear wheels, so that an antilock control device is operable during the operation of the automatic braking device;
said receiver outputting a control signal in response to the signal transmitted by the transmitter; and
said automatic braking device being operated in response to the control signal outputted by the receiver.

3. The operating unit of a vehicle having an automatic braking device according to claim 1, further comprising reference value setting means provided in the vehicle, and wherein the automatic braking device is operated based on a reference value corresponding to a target travelling speed set by the reference value setting means in response to the control signal.

4. The operating unit of a vehicle having an automatic braking device according to claim 1, further comprising travelling speed detection means provided in the vehicle for detecting a travelling speed of the vehicle in response to the control signal and outputting an output signal so as to operate the automatic braking device.

5. The operating unit of a vehicle having an automatic braking device according to claim 1, further comprising at least one temperature detection means provided on the road for detecting that an atmospheric temperature reaches a given temperature and outputting a temperature signal, and wherein the transmitter transmits the signal in response to the temperature signal outputted by the temperature detection means.

6. An operating unit of a vehicle having an automatic braking device that is applied to the vehicle travelling on a road provided with a transmitter for transmitting a signal formed of an electromagnetic wave comprising:
said automatic braking device and a receiver being respectively provided in the vehicle, wherein the automatic braking device drives a pump when the receiver receives the signal formed of an electromagnetic wave, operating an automatic brake to wheel brakes provided in a pair of right and left front wheels and/or rear wheels, so that an antilock control device is operable during the operation of the automatic braking device;
said receiver outputting a control signal in response to the signal transmitted by the transmitter; and
wherein an alarm is given to the inside of the vehicle by a sound in response to the control signal outputted by the receiver.

7. An operating unit of a vehicle having an automatic braking device comprising:
a transmitter provided on a road for transmitting a signal formed of an electromagnetic wave;
said automatic braking device and a receiver being respectively provided in the vehicle, wherein the automatic braking device drives a pump when the receiver receives the signal formed of an electromagnetic wave, operating an automatic brake to wheel brakes provided in a pair of right and left front wheels and/or rear wheels, so that an antilock control device is operable during the operation of the automatic braking device;
said receiver outputting a control signal in response to the signal transmitted by the transmitter; and
wherein an alarm is given to the inside of the vehicle by a sound in response to the control signal outputted by the receiver.

8. The operating unit of a vehicle having an automatic braking device according to claim 6, further comprising at least one temperature detection means provided on the road for detecting that an atmospheric temperature reaches a given temperature and outputting a temperature signal, and wherein the transmitter transmits the signal in response to the temperature signal outputted by the temperature detection means.

9. The operating unit of a vehicle having an automatic braking device according to claim 8, wherein the temperature detection means is provided in a tunnel.

10. The operating unit of a vehicle having an automatic braking device according to claim 9, wherein the transmitter is provided at one of the position of an opening portion serving as an approach to the tunnel and the position remote from the opening portion serving as the approach to the tunnel by a given distance.
